(19) United States
(12) Patent Application Publication
(10) Pub. No.: US 2013/0092052 A1
(43) Pub. Date: Apr. 18, 2013

(54) ALKYL- AND AMINO-FUNCTIONALIZED SILOXANES COMPRISING BIS(ALKOXYSILYL)AMINE FOR THE MASS HYDROPHOBIZATION OF INORGANIC BUILDING MATERIALS

(71) Applicants: Manuel Friedel, Zuerich (CH); Spomenko Ljesic, Rheinfelden (DE)

(72) Inventors: Manuel Friedel, Zuerich (CH); Spomenko Ljesic, Rheinfelden (DE)

(73) Assignee: EVONIK DEGUSSA GmbH, Essen (DE)

(21) Appl. No.: 13/640,638

(22) PCT Filed: Feb. 14, 2011
(86) PCT No.: PCT/EP2011/052100

§ 371 Date: Dec. 21, 2012

(30) Foreign Application Priority Data
Apr. 12, 2010 (DE) 102010003869.5

(51) Int. Cl. C04B 24/42

(52) U.S. Cl. CPC C04B 24/42
USPC 106/287.11; 106/481

(57) ABSTRACT

The invention relates to a composition for the hydrophobization, preferably the mass hydrophobization, of inorganic building materials, in particular substantially non-siliceous building materials containing inorganic alkali metals and/or alkaline earth metals, comprising at least one water-soluble amino- and alkyl-functional co-condensate siloxane and a bis(alkoxysilyl)amine, as well as to the hydrolysis products thereof, to a method for producing said composition, and also to the use of the composition for mass-hydrophobization, preferably of gypsum.

The invention relates to a composition for hydrophobizing; preferably for the mass hydrophobization of mineral building materials, more particularly of substantially nonsilicatic mineral building materials comprising alkali metal and/or alkaline earth metal, said composition comprising at least one water-soluble, amino- and alkyl-functional cocondensate siloxane and a bis(alkoxysilyl)amine and also the hydrolysis products thereof, to a method for producing this composition, and also to the use of the composition for the mass hydrophobization of, preferably, gypsum.

Gypsum is used under diverse service conditions as a building and engineering material. The skilled person is aware that gypsum is calcium sulfate, which may be present in different stages of hydration. Owing to the ease of removability of water (dehydration) from the CaSO₄.2H₂O, which for example is naturally occurring or is obtained from industrial processes, gypsum has a diverse application territory. The addition of water to dehydrated gypsum anhydrite or gypsum hemihydrate is accompanied by formation of a crystalline microstructure, giving it a more or less high strength and allowing it then to be used as building material. Gypsum products such as gypsum plasterboard and gypsum fiberboard are frequently produced by premixing gypsum anhydrite or gypsum hemihydrate in water and applying the resultant gypsum slurry to cardboard on large belt systems, covering the slurry with a second layer of cardboard, converting this product into a desired shape, and causing it to set (Gypsum data book, Bundesverband der Gipsindustrie e.V. (Ed.), 2006).

In wet rooms or outdoor applications, however, there are limits to the usefulness of gypsum as a building material, since gypsum, even after having set, possesses a certain solubility in water and would dissolve if wetted through. Consequently, gypsum boards and gypsum elements are employed that have been given a water-repelling (hydrophobic) treatment. Particularly desirable and economical is the hydrophobizing of gypsum elements in the mass (mass hydrophobization) during the actual production process. In this context it is advantageously possible to admix the aqueous gypsum slurry with an additive that gives the set material the hydrophobic properties. This additive is advantageously an aqueous system or a system which is readily soluble and/or dispersible in water and which can be added together with the make-up water to the dewatered gypsum anhydrite or gypsum hemihydrate.

Thus U.S. 2007/0028809 discloses the joint use of monomeric siliconates and a hydroxycellulose for the hydrophobizing treatment of gypsum. U.S. Pat. No. 5,110,684, WO 00/47536, DE 4124892, and DE 10220659 each relate to the use of hydridically H-substituted siloxanes, optionally in the presence of a further substituted silane, for the water-repelling treatment of gypsum. The hydrogen which is produced when such H-substituted siloxanes are used imposes exacting requirements on workplace protection and the safety precautions.

EP 1112986 and U.S. 2006/0107876 each disclose methods for producing water-repelling gypsums by adding silanes and/or siloxane and at least one additional catalyst to a gypsum mixture. Thus U.S. 2006/0107876 discloses the use of a glycol-functionalized siloxane in the presence of alkali metal hydroxides. EP 1112986 relates to the use of hydridically substituted siloxanes and a catalyst, such as Portland cement.

GB 2433497 discloses hydrophobized gypsum mixtures obtained by adding the pulverulent gypsum to a hydrolyzable organosilane, water and a catalyst, the organosilane not being hydrolyzed until the gypsum is present. For this purpose it is recommended not to add the catalyst until immediately before the addition of the gypsum in piece form to the monomeric organosilanes. A disadvantage of the mixtures described is the VOC content of the alkoxysilanes preferably used. Moreover, the reactivity of the alkoxysilanes in such gypsum mixtures, if only catalytic amounts of, for example, sodium hydroxide are added, is low, and the water repellency effect achievable in this way is generally not sufficient, as demonstrated by the examples disclosed.

EP 0 819 663 B1 discloses a gypsum mixture in which a physical mixture of a silane substituted by lower alkyl groups and also a trialkoxysilane substituted by amino groups, amino-lower alkyl-amino groups or dialkylenetriamine groups are uniformly dispersed. As possible weight ratios of the two silanes, 1:1 to 9:1 is stated. The overall aqueous gypsum mixture is VOC-containing and still contains the entirety of the hydrolysis alcohol of the two silanes. This VOC content is a disadvantage in the industrial production of gypsum plasterboard, since it necessitates special safety measures for keeping the ambient air clean and in relation to fire protection. Moreover, the gypsum formed is excessively porous. EP 0796826 discloses hydrophobic gypsum mixtures which comprise polysiloxanes as well as the silane mixtures described in EP 0819663. These polysiloxanes are H-substituted polysiloxanes, with the disadvantages elucidated above.

Known from WO 2007/009935, finally, is a method in which the VOC content of the hydrophobizing components is lowered by the preparation of a precondensate before the resultant siloxane is added to the gypsum mixture. A disadvantage, again, is the need to add a second catalyst to the gypsum mixture. If this second catalyst is omitted, the water repellency effect that can be achieved is not reliably of sufficient extent.

It is an object of the present invention, accordingly, to provide a composition and a method allowing the hydrophobizing of mineral building materials, more particularly of gypsum, in the mass, without the release of harmful, volatile substances and/or without the need to use any additional catalyst.

The object is achieved in accordance with the invention as detailed in the claims. More particularly, the object is achieved by the composition of the invention corresponding to the features of claim 1, and also by the production method of the invention according to claim 7. Preferred embodiments are set out in the dependent claims and also in the description.

Surprisingly it has been possible to achieve the object of hydrophobizing mineral building materials in the mass with the compositions of the invention. The invention provides compositions for the mass hydrophobization of mineral building materials, more particularly of substantially nonsilicatic building materials comprising alkali metal and/or alkaline earth metal, said compositions comprising as hydrophobizing agents a (i) water-soluble, amino- and alkyl-functional cocondensate siloxane and a (ii) bis(alkoxysilyl)amine and also, optionally, the hydrolysis and/or condensation products thereof, where the ratio of amino-functional groups A and B to alkyl-functional groups C and/or D in the composition is in the range from 1:10 to 10:1, preferably 1:5 to 5:1, very preferably 1:3 to 3:1

The invention accordingly provides a composition, more particularly for mass hydrophobization of mineral building materials, comprising substantially water and as hydrophobizing agents

(i) water-soluble, amino- and alkyl-functional cocondensate siloxanes, where the siloxanes are derived in particular from corresponding alkoxysilanes
such as the corresponding, methoxy- or ethoxy-substituted silanes known to the skilled person
and crosslinking structural elements which form catenary, cyclic and/or crosslinked structures, with at least one structure corresponding in idealized form to the general formula I,

(R²O)[(R²O)₁₋ₓ(R³)ₓSi(B)O]_{b}[Si(C)(R⁵)_{y}(OR⁴)_{1-y}O]_{c}[Si(D)₂O]_{d}R⁶.(HX)ₑ (I)

where in the structural elements derived from alkoxysilanes
B independently corresponds to an aminoalkyl radical of the general formula IVa or IVb

R¹⁰_{h*}NH_{(2-h*)}[(CH₂)ₕ(NH)]ⱼ[(CH₂)ₗ(NH)]ₙ—(CH₂)ₖ— (IVa),
in which h, l, and k independently correspond to an integer; 0≦h≦6; 0≦l≦6; 0≦k≦6, h*=0, 1 or 2, j=0, 1 Or 2; n=0, 1 or 2; and R¹⁰ corresponds to a benzyl, aryl, vinyl or formyl radical and/or to a linear, branched and/or cyclic alkyl radical having 1 to 8 C atoms, and/or

[NH₂(CH₂)ₘ]₂N(CH₂)ₚ— (IVb),
where m and p independently correspond to an integer, with 0≦m≦6 and 0≦p≦6,
C corresponds to a linear, branched or cyclic alkyl radical having 1 to 20 C atoms,
D independently in each case corresponds to a linear, branched or cyclic alkyl radical having 1 to 8 C atoms, and
where R², R⁴ and/or R⁶ independently correspond substantially to hydrogen, and R³ and/or R⁵ independently correspond to a linear, branched or cyclic alkyl radical having 1 to 4 C atoms and/or aryl radical, and
HX represents an acid, where X is an inorganic or organic acid radical,
with x=0 or 1, y=0 or 1, with b, c, d, and e independently integers and b≧1, c≧0, d≧0, e≧0, with the proviso that (c+d)≧1
where the cocondensates on crosslinking no longer release substantially any alcohol, and

(ii) a bis(alkoxysilyl)amine of the formula II

(OR¹)_{3-z}(R⁷)_{z}Si-A-Si(R⁷)_{z}(OR¹)_{3-z} (II)

where A is a divalent amine, R¹ independently is hydrogen or a linear, branched or cyclic alkyl radical having 1 to 4 C atoms, and R⁷ independently is a linear, branched or cyclic alkyl radical having 1 to 6 C atoms, with z=0 or 1, preferably z=0; or the hydrolysis and/or condensation products thereof, optionally with a siloxane from (i). In formula II, A preferably stands for a bis-amino-functional group of the formula III

—(CH₂)ᵢ—[NH(CH₂)_{f}]_{g}NH[(CH₂)_{f*}NH]_{g*}—(CH₂)_{i*}— (III),

in which i, i*, f, f*, g or g* independently corresponds to integers and are identical or different, with i and/or i*=0, 1, 2, 3, 4, 5, 6, 7 or 8, f and/or f*=1, 2 or 3, g and/or g*=0, 1 or 2.

As stated, h, l and k in formula IVa independently, and also m or p in formula IVb independently, may correspond to a number selected from 1, 2, 3, 4, 5 or 6. Preferably in formula IVa k=1 or 3 with h=2 and/or l=2, more particularly with j=1 and n=1; alternatively it is possible for h to be 2 and j to be 1 with n 0=. Equally preferably, k=6 with j=0, n=0, and h*=0. In formula IVb, preferably, p=1 or 3 with m=2.

The compositions of the invention have a lower VOC content than known compositions for hydrophobizing mineral building materials in the mass, and so the gypsum plasterboards or gypsum elements produced using these compositions do not have the stated disadvantages of the kind known from the prior art. Moreover, as a result of the addition of a bis(alkoxysilyl)amine, the mass hydrophobizing is significantly better than in the case of the use of the cocondensate siloxane alone.

Contemplated as inorganic or organic acid radical are known acid radicals customary to the skilled person, which may be formed, for example, by addition of HCl, HNO₃, H₂SO₄, H₃PO₄, formic acid, acetic acid and also other customary acids.

Bis(alkoxysilyl)amines of the formula II that are inventive accordingly are as follows: bis(alkoxysilyl)alkylenamines, bis(trialkoxysilylalkyl)amine, bis-N, N′-(trialkoxysilylalkyl)alkylenediamine and/or bis-N,N′-(trialkoxysilylalkyl)dialkylenetriamine, more particularly bis(trialkoxysilylpropyl)amine, bis(triethoxysilylpropyl)amine, (H₅C₂O)₃Si(CH₂)₃NH(CH₂)₃Si(OC₂H₅)₃, bis-AMEO), bis(trimethoxysilylpropyl)amine ((H₃CO)₃Si(CH₂)₃NH(CH₂)₃Si(OCH₃)₃, bis-AMMO, bis-DAMO ((H₃CO)₃Si(CH₂)₃NH(CH₂)₂NH(CH₂)₃Si(OCH₃)₃) and/or bis-TRIAMO ((H₃CO)₃Si(CH₂)₃NH(CH₂)₂NH(CH₂)₂NH(CH₂)₃Si(OCH₃)₃), bis(diethoxymethylsilylpropyl)amine, bis(dimethoxymethylsilylpropyl)amine, bis(triethoxysilylmethyl)amine, bis(trimethoxysilylmethyl)amine, bis(diethoxymethylsilylmethyl)amine, bis(dimethoxymethylsilylmethyl)amine, (H₃CO)₂(CH₃)Si(CH₂)₃NH(CH₂)₂NH(CH₂)₃Si(OCH₃)₂(CH₃) and/or (H₃CO)₃(CH₃)Si(CH₂)₃NH(CH₂)₂NH(CH₂)₂NH(CH₂)₃Si(OCH₃)₂(CH₃), and also the respectively ethoxy-substituted rather than methoxy-substituted bis(alkoxysilyl)amines, with particular preference being given to bis(triethoxysilylpropyl)amine ((H₅C₂O)₃Si(CH₂)₃NH(CH₂)₃Si(OC₂H₅)₃, bis-AMEO.

Where reference is made below to siloxanes, it is always the cocondensate siloxanes according to the invention that are meant. Cocondensate siloxanes of the formula I that can be used with preference include the following:

as amino-functional structural elements, more particularly [(R²O)₁₋ₓ(R³)ₓSi(B)O] with x=0 or 1, x preferably being 0, they have preferably the following as amino-functional group and optionally, additionally, as alkyl group: aminopropyl-, diaminoethylene-3-propyl-, triaminodiethylene-3-propyl-, H₂N(CH₂)₂NH(CH₂)₂NH(CH₂)₃Si(OCH₃)₃, aminopropyl- and methyl- as R³; 2-aminoethyl-, 2-aminoethyl- and methyl- as R³, 6-amino-n-hexyl-, 6-amino-n-hexyl- and and methyl- as R³; 3-amino-n-propyl-, 1-aminomethyl-, 1-aminomethyl- and methyl- as R³; N-butyl-3-aminopropyl-, N-butyl-3-aminopropyl- and methyl- as R³; N-butyl-1-aminomethyl-, N-butyl-1-aminomethyl-, and methyl- as R³; N-formyl-3-aminopropyl-, N-formyl-3-aminopropyl- and methyl- as R³.

Cocondensate siloxanes of the formula I that can be used with preference comprise as purely alkyl-functional structural elements, more particularly independently [Si(C)(R⁵)_{y}(OR⁴)_{1-y}O] and/or [Si(D)₂O] with y=0 or 1, y preferably being 0, the following alkyl groups independently as C and/or D: C a linear or branched alkyl radical having 1 to 20 C atoms, more particularly having 1 to 8 C atoms, preferably a methyl, ethyl, more preferably n-propyl, isopropyl, n-butyl, isobutyl, hexyl or octyl radical; D a linear, branched or cyclic alkyl radical having 1 to 8 C atoms, preferably a methyl, ethyl, more preferably n-propyl, isopropyl, n-butyl, isobutyl, pentyl, hexyl, heptyl and/or octyl radical, preferably an n-propyl, n-butyl, isobutyl or octyl radical.

Generally, the cocondensates may be linear oligomers having M and D structures, or cyclic structures comprising D structures, or else crosslinked oligomers having M, D, and T structures, of the kind sufficiently well known to the skilled person for cocondensates composed of alkoxysilanes and linked via siloxane (O—Si—O—) bridges, as may be formed from alkoxysiloxanes by hydrolysis and at least partial condensation. The cocondensates used may be unregulatedly, randomly distributed cocondensates and/or block cocondensates.

Particularly preferred compositions have a ratio of amino-functional groups A and B to alkyl-functional groups C and/or D in the composition in a range from 1:10 to 10:1, preferably 1:5 to 5:1, very preferably 1:3 to 3:1. It has emerged that these compositions, even at a very low concentration, exhibit outstanding hydrophobizing properties in mass hydrophobization, more particularly in the case of gypsum.

The cocondensate siloxanes are prepared preferably by hydrolysis and/or condensation of amino-functionalized alkoxysilanes such as B—Si(R³)ₓ(OR²)₃₋ₓ in the presence of at least one alkyltrialkoxysilane and/or a dialkyldialkoxysilane, and more particularly they are cocondensed or block-cocondensed, and the resultant hydrolysis alcohol, and any added alcohol, has been removed by measures known to the skilled person. Examples of aminoalkylalkoxysilanes which can be used with preference for preparing the cocondensate siloxanes are as follows: aminopropyltrimethoxysilane (H₂N(CH₂)₃Si(OCH₃)₃, AMMO), aminopropyltriethoxysilane (H₂N(CH₂)₃Si(OC₂H₅)₃, AMEO), diaminoethylene-3-propyltrimethoxysilane (H₂N(CH₂)₂NH(CH₂)₃Si(OCH₃)₃, DAMO); triaminodiethylene-3-prolytrimethoxysilane H₂N(CH₂)₂NH(CH₂)₂NH(CH₂)₃Si(OCH₃)₃ (TRIAMO), aminopropylmethyldiethoxysilane, aminopropylmethyldimethoxysilane, 2-aminoethyltrimethoxysilane, 2-aminoethylmethyldimethoxysilane, 2-aminoethylphenyldimethoxysilane, 2-aminoethyltriethoxysilane, 2-aminoethylmethyldiethoxysilane, 2-aminoethyltriethoxysilane, (2-aminoethylamino)ethyltriethoxysilane, 6-amino-n-hexyltriethoxysilane, 6-amino-n-hexyltrimethoxysilane, 6-amino-n-hexylmethyldimethoxysilane and also, in particular, 3-amino-n-propyltrimethoxysilane, 3-amino-n-propylmethyldimethoxysilane, 3-amino-n-propyltriethoxysilane, 3-amino-n-propylmethyldiethoxysilane, 1-aminomethyltriethoxysilane, 1-aminomethylmethyldiethoxysilane, 1-aminomethyltrimethoxysilane, 1-aminomethylmethyldiethoxysilane, N-butyl-3-aminopropyltriethoxysilane, N-butyl-3-aminopropylmethyldiethoxysilane, N-butyl-3-aminopropyltrimethoxysilane, N-butyl-3-aminopropylmethyldimethoxysilane, N-butyl-1-aminomethyltriethoxysilane, N-butyl-1-aminomethylmethyldimethoxysilane, N-butyl-1-aminomethyltrimethoxysilane, N-butyl-1-aminomethylmethyltriethoxysilane, N-formyl-3-aminopropyltriethoxysilane, N-formyl-3-aminopropyltrimethoxysilane, N-formyl-1-aminomethylmethyldimethoxysilane and/or N-formyl-1-aminomethylmethyldiethoxysilane or mixtures thereof.

Preferred alkylalkoxysilanes stated by way of example for preparing the amino-functional cocondensate siloxanes correspond to one of the following general formulae: C—Si(R⁵)_{y}(OR⁴)_{3-y} or D₂Si(OR⁴)₂: such as propyltrimethoxysilane (PTMO), dimethyldimethoxysilane (DMDMO), dimethyldiethoxysilane, methyltriethoxysilane (MTES), propylmethyldimethoxysilane, propylmethyldiethoxysilane, n-octylmethyldimethoxysilane, n-hexylmethyldimethoxysilane, n-hexylmethyldiethoxysilane, propylmethyldiethoxysilane, propylmethyldiethoxysilane, propyltriethoxysilane, isobutyltrimethoxysilane, isobutyltriethoxysilane, octyltrimethoxysilane, octyltriethoxysilane, n-hexyltriethoxysilane, cyclohexyltriethoxysilane, n-propyltri-n-butoxysilane, n-propyltrimethoxysilane, n-propyltriethoxysilane, isobutyltriethoxysilane, hexadecyltriethoxysilane, hexadecyltrimethoxysilane, octadecyltriethoxysilane, octadecyltrimethoxysilane, octadecylmethyldiethoxysilane, octadecylmethyldimethoxysilane, hexadecylmethyldimethoxysilane and/or hexadecylmethyldiethoxysilane, and also mixtures of these silanes.

A feature of the compositions of the invention is that in the composition consisting of cocondensate siloxane, more particularly of the formula I, and bis(alkoxysilyl)amine of the formula II and also the hydrolysis and/or condensation products thereof, and optionally water, they exhibit only a low VOC content of somewhat above >200 g/l, preferably below 150 g/l, more preferably below 100 g/l, determined in accordance with ASTM D5095-91.

The invention also provides compositions comprising at least one mineral building material, more particularly at least one substantially nonsilicatic building material comprising alkali metal and/or alkaline earth metal, the building material being more particularly an alkali metal carbonate and/or alkaline earth metal carbonate, independently of one another as anhydrate, as hydrate, a modification of these or mixtures thereof, preferably an alkaline earth metal sulfate, alkali metal sulfate, alkaline earth metal carbonate, alkali metal carbonate or a mixture comprising at least one of these compounds, more preferably CaSO₄, CaSO₄.xH₂O, with x=0, 0.5 or 2; CaCO₃, MgCO₃, BaCO₃, Na₂CO₃, K₂CO₃, preference being given to calcium sulfate in various hydration forms, more particularly calcium dihydrate, calcium hemihydrate, calcium sulfate anhydrite; calcium carbonate, magnesium carbonate, barium carbonate, potassium carbonate, sodium carbonate in each case in the form of the naturally occurring or synthetically produced minerals, and also water-free or water-containing, or modifications thereof. In accordance with the invention, calcium sulfate in various hydration forms, more particularly as calcium hemihydrate and/or calcium sulfate anhydrite, is used in the composition.

Additionally, the composition of the invention which is suitable for mass hydrophobization of mineral building materials may comprise at least one mineral building material, water, and, as hydrophobizing agents, the cocondensate, more particularly the siloxane of the formula I, and the bis(alkoxysilyl)amine of the formula II, a mixture of these or the hydrolysis and/or condensation products thereof, the amount of hydrophibizing agent in this composition being 0.002% to 10% by weight, more particularly 0.01% to 5% by weight, preferably 0.1% to 4% by weight, more preferably 0.1% to 3.5% by weight, with particular preference 0.2% to 3.0% by weight, with further preference 0.2% to 1.0% by weight, with building material and water to make up the composition to 100% by weight.

The invention also provides a method for producing a composition, more particularly for the mass hydrophobization of mineral building materials, and also a composition obtainable by this method, by preparing a mixture comprising

(i) water-soluble, amino- and alkyl-functional cocondensate siloxanes and water, the siloxanes being particularly derived from alkoxysilanes and having crosslinking structural elements which form catenary, cyclic and/or crosslinked structures, with at least one structure corresponding in idealized form to the general formula I,

(R²O)[(R²O)₁₋ₓ(R³)ₓSi(B)O]_{b}[Si(C)(R⁵)_{y}(OR⁴)_{1-y}O]_{c}[Si(D)₂O]_{d}R⁶.(HX)ₑ (I)

where in the structural elements derived from alkoxysilanes
B independently corresponds to an aminoalkyl radical of the general formula IVa or IVb

R¹⁰_{h*}NH_{(2-h*)}[(CH²)ₕ(NH)]ⱼ[(CH₂)ₗ(NH)]ₙ—(CH₂)ₖ— (IVa),
in which h, l, and k independently of one another correspond to integers, 0≦h≦6; 0≦l≦6, 0≦k≦6, h*=0, 1 or 2, j=0, 1 or 2; n=0, 1 or 2; and R¹⁰ corresponds to a benzyl, aryl, vinyl or formyl radical and/or a linear, branched and/or cyclic alkyl radical having 1 to 8 C atoms, and/or

[NH₂(CH₂)ₘ]₂N(CH₂)ₚ— (IVb),
where m and p correspond to integers, with 0≦m≦6 and 0≦p≦6,
C corresponds to a linear, branched or cyclic alkyl radical having 1 to 20 C atoms,
D independently in each case corresponds to a linear, branched or cyclic alkyl radical having 1 to 8 C atoms, and
where R², R⁴ and/or R⁶ independently correspond substantially to hydrogen, and R³ and/or R⁵ independently correspond to a linear, branched or cyclic alkyl radical having 1 to 4 C atoms and/or aryl radical and
HX represents an acid, where X is an inorganic or organic acid radical, as elucidated above, with x=0 or 1, y=0 or 1, b, c, d, and e integers with b≧1, c≧0, d≧0, e≧0, with the proviso that (c+d)≧1; where the cocondensates on crosslinking no longer release substantially any alcohol, and

(ii) a bis(alkoxysilyl)amine of the formula II

(OR¹)_{3-z}(R⁷)_{z}Si-A-Si(R⁷)_{z}(OR¹)_{3-z} (II),

where A is a divalent amine, R¹ independently is hydrogen or a linear, branched or cyclic alkyl radical having 1 to 4 C atoms, and R⁷ independently is a linear, branched or cyclic alkyl radical having 1 to 6 C atoms, with z=0 or 1; or the hydrolysis and/or condensation products thereof

(iii) by mixing the compounds from (i) and (ii), and forming the hydrophobizing agent.

As defined above, preferably a bis(alkoxysilyl)amine of the formula II is used with A in formula II of a bis-amino-functional group of the formula III

—(CH₂)ᵢ—[NH(CH₂)_{f}]_{g}NH[(CH₂)_{f*}NH]_{g*}—(CH₂)_{i*}— (III),

in which i, i*, f, f*, g or g* independently corresponds to integers and are identical or different, with i and/or i*=0, 1, 2, 3, 4, 5, 6, 7 or 8, f and/or f*=1, 2 or 3, g and/or g*=0, 1 or 2. The bis(alkoxysilyl)amines used with preference are elucidated in detail above.

It has proven particularly advantageous if in the method a ratio of the amino-functional groups A and B to alkyl-functional groups C and D in the range from 1:10 to 10:1 is set, preferably 1:5 to 5:1, very preferably 1:3 to 3:1. Mineral building materials hydrophobized in the mass with these compositions exhibit very good hydrophobizing properties, even when the amount of hydrophobizing agent added is only small, and they reduce, for example, the water absorbency of gypsum from over 24% by weight to about 1.2% by weight.

The method of the invention preferably comprises the following step, in which (i) the at least one cocondensate, more particularly the siloxane of the formula I, and at least one bis(alkoxysilyl)amine of the formula II, preferably bis(triethoxysilylpropyl)amine or bis(trimethoxysilylpropyl)amine, a mixture of these or the hydrolysis and/or condensation products thereof, and optionally water, is mixed with (ii) a mixture comprising at least one mineral building material, more particularly a substantially nonsilicatic building material comprising alkali metal and/or alkaline earth metal, and water, preferably a calcium sulfate in different hydration forms, more preferably a calcium hemihydrate or calcium sulfate anhydrite. More preferably the mineral building material comprising alkali metal and/or alkaline earth metal is a gypsum, gypsum anhydrite, gypsum hemihydrate, calcite, calcspar, magnesite, limestone, chalk, boiler scale, marble, dolomite, aragonite, magnesite witherite, potash, soda, in each case water-free or water-containing, and/or a mixture comprising the aforementioned minerals, more particularly naturally occurring or synthetically produced, the building material being more particularly a gypsum anhydrite, gypsum hemihydrate. In the method it is preferred to set a ratio of building material to water of 4:1 to 1:4, more particularly for gypsum, gypsum anhydrite and/or gypsum hemihydrate to water of 4:1 to 1:4, preferably to about 1:2.

With further preference in the method a composition comprising at least one mineral building material, water, and also, as hydrophobizing agents, at least one cocondensate, more particularly siloxane of the formula I, and bis(alkoxysilyl)amine of the formula II, a mixture of these or the hydrolysis and/or condensation products thereof is prepared, the amount of hydrophobizing agent in this composition being set at 0.002% to 10% by weight, more particularly at 0.01% to 5% by weight, preferably to 0.01% to 4% by weight, more preferably to 0.1% to 3.5% by weight, with particular preference to 0.2% to 3.0% by weight, with further preference to 0.2% to 1.0% by weight, with building material and water to make up the composition to 100% by weight. In subsequent method steps, there may be shaping of the composition comprising water and building material. In a subsequent method step, therefore, there may be (i) optional shaping and (ii) curing.

The invention also provides a method for producing a composition as described above, where, more particularly, the water-containing composition (i) is optionally shaped, and (ii) is cured. Depending on what is required, water supernatant after shaping may be decanted off or removed by other measures, such as filtration. To the skilled person it is clear that the curing may take place by an active drying process and also under ambient conditions. As a result of this method step, a mass-hydrophobized composition is obtained, comprising a cocondensate siloxane, more particularly of the formula I, and a bis(alkoxysilyl)amine of the formula II, the hydrolysis and/or condensation products thereof and/or reaction products thereof.

The invention also provides a method in which (i) at least one cocondensate siloxane, more particularly of the formula I, and a bis(alkoxysilyl)amine of the formula II are mixed with a ratio of the amino-functional groups A and B to alkyl-functional groups C and/or D in the range from 1:10 to 10:1, preferably 1:5 to 5:1, very preferably 1:3 to 3:1; and (ii) gypsum anhydrite or gypsum hemihydrate is mixed with water; more particularly in a ratio of 4:1 to 1:4, preferably of 3:1 to 1:3, more preferably of 3:1 to 1:1, even more preferably around 2:1; and (iii) the mixture from (i) is added to the mixture from (ii) and the combined mixture is preferably homogenized, after which (iv) optionally the mixture prepared in (iii) is transferred to a mold or transferred onto a belt, which may be a filter belt, and (v) curing is carried out. In step (iv), application to cardboard may also be envisaged.

Furthermore, the composition of the invention may be admixed with at least one more of the following components from the series of pigments, fillers, binders, crosslinkers, optical brighteners, film-forming auxiliaries or other auxiliaries.

The invention also provides for the use of the composition of the invention, comprising the cocondensate siloxane and bis(alkoxysilyl)amine and/or the hydrolysis or condensation products thereof, for the mass hydrophobization of mineral building materials, more particularly of substantially nonsilicatic mineral building materials comprising alkali metal and/or alkaline earth metal, preferably of alkali metal sulfate and/or alkaline earth metal sulfate, alkali metal carbonate and/or alkaline earth metal carbonate, which comprise the alkali metals and alkaline earth metals, and are present independently of one another as anhydrate, as hydrate, as modifications thereof or as a mixture; for the mass hydrophobization of elements of mineral building materials, for the treatment, modification, production of coatings, formulations, substrates, articles, organic or inorganic materials or composite materials, or for the coating of substrates, for hydrophobization and oleophobization and also for the dirt-repellency and ink/paint-repellency treatment of surfaces or porous substrates, metals, plastics, for the protection of buildings and facades.

The examples below elucidate the present invention and also the compositions of the invention in more detail, without confining the invention to these examples.

### Preparation Example 1

A 500 ml laboratory stirred reactor with temperature sensor, dropping funnel, and reflux condenser is charged under nitrogen blanketing with 442 g of 3-aminopropyltriethoxysilane and 356 g of isobutyltrimethoxysilane. Over the course of 30 minutes, 144 g of water are added dropwise. The temperature during this addition is not to rise above 60° C., with cooling being carried out if appropriate. The reaction mixture is stirred at 60° C. for 2 hours. Thereafter the reflux condenser is replaced by a distillation bridge and 50% (about 234 g) of the hydrolysis alcohol formed is distilled off. A mixture of 500 g of water, 120.5 g of formic acid, and 0.42 g of hydrochloric acid is subsequently added dropwise over the course of 30 minutes. The temperature during this addition ought again not to rise above 60° C., with cooling being carried out if appropriate. At a pressure of 150 mbar and a liquid-phase temperature of 50° C., a methanol/ethanol/water mixture is then distilled off over the course of about 5 hours and at the same time is replaced by water. Water in this case is added dropwise, such that the volume of the solution remains constant.

When the overhead temperature is about 50° C. and the top product consists only of water, the distillation is ended.

### EXAMPLE 1

### Production of Composition with Cocondensate Siloxane/bis(alkoxysilyl)amine Mixture as Hydrophobizing Agent

In a clean, dry glass vessel, the product from preparation example 1 is mixed in a ratio of 1:6 with bis(triethoxysilylpropyl)amine. The mixture is stirred for a number of minutes and then used.

### EXAMPLE 2

### Production of Composition with Hydrophobizing Agent, Building Material and Water—Production of the Gypsum Specimens

2.1 Reference:

Unmodified commercially available gypsum (for example from Knauf) is admixed with water in a vessel. The water:gypsum mass ratio here corresponds to 0.5. This mixture can cure for 4 days.

2.2 Inventive:

Unmodified commercially available gypsum (for example from Knauf) is admixed with water in a vessel. The water-to-gypsum mass ratio here corresponds to 0.5. The mixture prepared under example 1 introduced into this mixture and the combined mixture is homogenized by stirring. Subsequently the composition can cure for 4 days.

2.3 Testing of the Gypsum Specimens:

Underwater storage takes place in accordance with the provisions of DIN EN 520. A measurement is made of the increase in weight of the test specimens. The increase in weight is to be less than 5% by weight. The table below shows the results of testing.

| | | Weight increase after |
|---|---|---|
| | Amount of addition | underwater storage |
| Test specimen | (based on gypsum) | (DIN EN 530) |
| 3.1 untreated | — | 24.4% by weight |
| 3.2 inventive | 0.5% by weight | 1.2% by weight |
| Cocondensate siloxane | 2.0% by weight | 3.1% by weight |
| of AMEO/ | | |
| isobutyltrimethoxysilane | | |

1. A composition comprising water and a hydrophobizing agent, wherein the hydrophobizing agent comprises (i) and (ii):
(i) a water-soluble, amino- and alkyl-functional cocondensate siloxane derived from an alkoxysilane and having at least one crosslinking structural element that forms a catenary structure, a cyclic structure, or a crosslinked structure, where at least one structure corresponds in idealized form to formula I,
(R²O)[(R²O)₁₋ₓ(R³)ₓSi(B)O]_{b}[Si(C)(R⁵)_{y}(OR⁴)_{1-y}O]_{c}[Si(D)₂O]_{d}R⁶.(HX)ₑ (I)
where
B independently corresponds to an aminoalkyl radical of formula IVa or IVb
R¹⁰_{h*}NH_{(2-h*)}[(CH₂)ₕ(NH)]ⱼ[(CH₂)ₗ(NH)]ₙ—(CH₂)ₖ— (IVa),
in which h, l, and k independently correspond to an integer; 0≦h≦6; 0≦l≦6; 0≦k≦6, h*=0, 1 or 2, j=0, 1 or 2; n=0, 1 or 2; and R¹⁰ corresponds to a benzyl, aryl, vinyl or formyl radical or to a linear, branched or cyclic alkyl radical having 1 to 8 C atoms,
[NH₂(CH₂)ₘ]₂N(CH₂)ₚ— (IVb),
where m and p independently correspond to an integer, with 0≦m≦6 and 0≦p≦6,
C corresponds to a linear, branched or cyclic alkyl radical having 1 to 20 C atoms,
D independently in each case corresponds to a linear, branched or cyclic alkyl radical having 1 to 8 C atoms, and
where R², R⁴ and R⁶ are hydrogen, and
R³ and R⁵ independently correspond to a linear, branched or cyclic alkyl radical having 1 to 4 C atoms, or an aryl radical, and
HX represents an acid, where X is an inorganic or organic acid radical,
with x=0 or 1, y=0 or 1, with b, c, d, and e independently integers and b≧1, c≧0, d≧0, e≧0, with the proviso that (c+d)≧1
where on crosslinking, the cocondensate releases substantially
no alcohol, and
(ii) a bis(alkoxysilyl)amine of formula II
(OR¹)_{3-z}(R⁷)_{z}Si-A-Si(R⁷)_{z}(OR¹)_{3-z} (II)
where A is a divalent amine, R¹ independently is hydrogen or a linear, branched or cyclic alkyl radical having 1 to 4 C atoms, and R⁷ independently is a linear, branched or cyclic alkyl radical having 1 to 6 C atoms, with z=0 or 1; or a hydrolysis or condensation product thereof, optionally with a siloxane from (i).

2. The composition of claim 1, wherein
A in formula II is a bis-amino-functional group of formula III
—(CH₂)ᵢ—[NH(CH₂)_{f}]_{g}NH[(CH₂)_{f*}NH]_{g*}—(CH₂)_{i*}— (III),
in which i, i*, f, f*, g and g* are identical or different integers, with i and i*=0 to 8, f and f*=1, 2 or 3, g and g*=0, 1 or 2.

3. The composition of claim 1,
wherein
a ratio of amino-functional groups A and B to alkyl-functional groups C and D is in a range from 1:10 to 10:1.

4. The composition of claim 1, further comprising a
nonsilicatic building material comprising an alkali metal or an alkaline earth metal.

5. The composition of claim 1,
comprising 0.002% to 10% by weight of the hydrophobizing agent, and further comprising a mineral building material.

6. The composition of claim 1, wherein the
bis(alkoxysilyl)amine of formula II is at least one selected from the group consisting of
(H₅C₂O)₃Si(CH₂₃NH(CH₂)₃Si(OC₂H₅)₃, (H₃CO)₃Si(CH₂)₃NH(CH₂)₃Si(OCH₃)₃,
(H₃CO)₃Si(CH₂)₃NH(CH₂)₂NH(CH₂)₃Si(OCH₃)₃,
H₃CO)₃Si(CH₂)₃NH(CH₂)₂NH(CH₂)₂NH(CH₂)₃Si(OCH₃)₃,
(H₅C₂O)₃Si(CH₂)₃NH(CH₂)₂NH(CH₂)₃Si(OC₂H₅)₃,
(H₅C₂O)₃Si(CH₂)₃NH(CH₂)₂NH(CH₂)₂NH(CH₂)₃Si(OC₂H₅)₃,
bis(diethoxymethylsilylpropyl)amine, bis(dimethoxymethylsilylpropyl)amine,
bis(triethoxysilylmethyl)amine, bis(trimethoxysilylmethyl)amine,
bis(diethoxymethylsilylmethyl)amine, bis(dimethoxymethylsilylmethyl)amine,
(H₃CO)₂(CH₃)Si(CH₂)₃NH(CH₂)₂NH(CH₂)₃Si(OCH₃)₂(CH₃), and
(H₃CO)₃(CH₃)Si(CH₂)₃NH(CH₂)₂NH(CH₂)₂NH(CH₂)₃Si(OCH₃)₂(CH₃).

7. A method for producing a composition, the method comprising mixing (i) and (ii) to obtain a hydrophobizing agent:
(i) a water-soluble, amino- and alkyl-functional cocondensate siloxane and water, the siloxane being derived from an alkoxysilane and having at least one crosslinking structural element that forms a catenary structure, a cyclic structure, or a crosslinked structure, where, at least one structure corresponds in idealized form to formula I,
(R²O)[(R²O)₁₋ₓ(R³)ₓSi(B)O]_{b}[Si(C)(R⁵)_{y}(OR⁴)_{1-y}O]_{c}[Si(D)₂O]_{d}R⁶.(HX)ₑ (I)
where
B independently corresponds to an aminoalkyl radical of formula IVa or IVb
R¹⁰_{h*}NH_{(2-h*)}[(CH₂)ₕ(NH)]ⱼ[(CH₂)ₗ(NH)]ₙ—(CH₂)ₖ— (IVa),
in which h, l, and k independently of one another correspond to integers;
0≦h≦6, 0≦l≦6; 0≦k≦6, h*=0, 1 or 2, j=0, 1 or 2; n=0, 1 or 2; and R¹⁰ corresponds to a benzyl, aryl, vinyl or formyl radical or to a linear, branched or cyclic alkyl radical having 1 to 8 C atoms,
[NH₂(CH₂)ₘ]₂N(CH₂)ₚ— (IVb),
where m and p correspond to integers, with 0≦m≦6 and 0≦p≦6,
C corresponds to a linear, branched or cyclic alkyl radical having 1 to 20 C atoms,
D independently in each case corresponds to a linear, branched or cyclic alkyl radical having 1 to 8 C atoms, and
where R², R⁴ and R⁶ are hydrogen, and
R³ and R⁵ independently correspond to a linear, branched or cyclic alkyl radical having 1 to 4 C atoms, or an aryl radical, and
HX represents an acid, where X is an inorganic or organic acid radical,
with x=0 or 1, y=0 or 1, b, c, d, and e integers
with b≧1, c≧0, d≧0, e≧0, with the proviso that (c+d)≧1
where on crosslinking, the cocondensate releases substantially no alcohol, and
(ii) a bis(alkoxysilyl)amine of formula II
(OR¹)_{3-z}(R⁷)_{z}Si-A-Si(R⁷)_{z}(OR¹)_{3-z} (II),
where A is a divalent amine, R¹ independently is hydrogen or a linear, branched or cyclic alkyl radical having 1 to 4 C atoms, and R⁷ independently is a linear, branched or cyclic alkyl radical having 1 to 6 C atoms, with z=0 or 1; or a hydrolysis or condensation product thereof.

8. The method of claim 7,
wherein
A in formula II is a bis-amino-functional group of formula III
—(CH₂)ᵢ—[NH(CH₂)_{f}]_{g}NH[(CH₂)_{f*}NH]_{g*}—(CH₂)_{i*}— (III),
in which i, i*, f, f*, g and g* are identical or different integers, with i and i*=0 to 8, f and f*=1, 2 or 3,
g and g*=0, 1 or 2.

9. The method of claim 7,
wherein
a ratio of amino-functional groups A and B to alkyl-functional groups C and D is in a range from 1:10 to 10:1.

10. The method of claim 7,
wherein
(i) at least one siloxane of formula I and at least one bis(alkoxysilyl)amine of formula II, a mixture of these or a hydrolysis or condensation product thereof, and optionally water, are mixed with
(ii) a mixture comprising at least one mineral building material and water.

11. The method of claim 7,
wherein the composition comprises a mineral building material, water, and 0.002% to 10% by weight of the hydrophobizing agent.

12. The method of claim 10,
wherein
the mineral building material comprises at least one selected from the group consisting of a gypsum, gypsum anhydrite, gypsum hemihydrate, calcite, calcspar, magnesite, limestone, chalk, boiler scale, marble, dolomite, aragonite, magnesite, witherite, potash, and soda, in each case water-free or water-containing.

13. The method of claim 10,
wherein a
ratio of building material to water is in a range of 4:1 to 1:4.

14. The method of claim 10, further comprising
(i) optional shaping and (ii) curing.

15. A composition obtained by the method of claim 7.

16. A method of mass hydrophobizing a mineral building material, the method comprising contacting the composition of claim 1 with the mineral building material.

17. The composition of claim 1, wherein a ratio of amino-functional groups A and B to alkyl-functional groups C and D is in a range of 1:5 to 5:1.

18. The composition of claim 1, wherein a ratio of amino-functional groups A and B to alkyl-functional groups C and D is in a range of 1:3 to 3:1.

19. The composition of claim 1, comprising 0.2% to 1.0% by weight of the hydrophobizing agent and further comprising a mineral building material.

20. The composition of claim 1, wherein the bis(alkoxysilyl)amine of formula II is bis(triethoxysilylpropyl)amine.
